(19) United States
(12) Patent Application Publication
(10) Pub. No.: US 2008/0006320 A1
(43) Pub. Date: Jan. 10, 2008

(54) Photovoltaic apparatus

(76) Inventors: Gaute Dominic Magnussen Aas, Lysaker (NO); Lars G. Dysterud Hansen, Kongsvinger (NO)

Correspondence Address: YOUNG & THOMPSON, 745 SOUTH 23RD STREET, 2ND FLOOR, ARLINGTON, VA, 22202, US

(21) Appl. No.: 11/486,296

(22) Filed: Jul. 14, 2006

(30) Foreign Application Priority Data
Jul. 4, 2006 (NO) 20063098

(51) Int. Cl. H02N 6/00

(52) U.S. Cl. 136/246

(57) ABSTRACT

A cooling device (2) for a photovoltaic panel where the cooling device (2) comprises a basis layer (3) with a number of protruding structures (4) which protrudes from the basis layer (3) and where the cooling device (2) covers a substantial part of the back of the photovoltaic panel.

The present invention relates to a passive cooling device for photovoltaic panels/modules.

In order to comply with the world's growing energy needs, the use of solar energy is increasingly important. Over the last decade there has been an enormous increase in the use of photovoltaic cells. This has happened in accordance with the technological development and the accompanied price reduction of materials and other technology (for example inverters) which are used.

It is a problem that the output effect from photovoltaic cells is reduced when the temperature increases. On a hot summer day with direct sun exposure the cell temperature will quickly raise to more than 80° C. This problem increases of course with the use of photovoltaic cells in warmer climate, and applies for both photovoltaic cells based on focused light and for flat photovoltaic panels. Accordingly, there has been developed a large number of cooling devices for photovoltaic apparatuses, but none of them has gained commercial success for the use with ordinary photovoltaic panels. Photovoltaic cells based on focused light are almost completely dependent on having a cooling system in order to operate, and most of the development in cooling the devices has focused on the concentrator technology. Examples of cooling devices for photovoltaic apparatuses based on focused light can be found in U.S. Pat. No. 3,999,283, U.S. Pat. No. 5,498,297 and WO A1 96/15559.

Cooling can be provided by both active and passive systems. Active cooling systems include Rankine cycle system and absorption system, both of which require additional hardware and costs. Passive cooling systems make use of three natural processes: convection cooling, radiation cooling and evaporation cooling from water surfaces exposed to the atmosphere.

Often the temperature in the photovoltaic panels and modules are 30-50° C. higher than in the ambient air. This temperature increase results in 5-20% reduction of output effect from the photovoltaic panel. A disadvantage of many of the prior art cooling devices for photovoltaic panels and modules is that many of them are complicated and relatively costly to produce. Furthermore it has not been taken into consideration that a cooling device needs to be robust and maintenance free for the next 25-40 years which is the modules' life expectancy. None of the existing solutions has therefore awaked any great interest in the market of photovoltaic panels. Accordingly a need exists for a cooling system for photovoltaic panels and modules which is simple and inexpensive to produce and which is completely maintenance free.

An object of the present invention is to provide a passive cooling device which is simpler and less costly to produce than prior art cooling devices. It shall also be robust and maintenance free.

According to the invention there has been provided a cooling device for a photovoltaic panel which is characterized by a cooling device comprising a basis layer with a number of protruding structures which protrudes out from the basis layer and that the cooling device covers a substantial part of the back of the photovoltaic panel.

Preferable embodiments of the cooling device are set forth in the accompanying dependent claims 2 to 6.

By having a number of protruding structures on the back of the photovoltaic panels there is created a large surface area that can transfer heat to the surrounding air so that the photovoltaic panel is being cooled. The cooling structures can preferably have the form of ribs or fins. By using lower, more and thinner cooling ribs the production can be made simpler and less costly since less material is used and thereby the cooling device will have a smaller weight. By using longer and thicker cooling ribs there will be increased strength and rigidity of the panel.

Another advantage of the invention is that the photovoltaic panel will be more rigid and get increased strength so that the photovoltaic panel including the cooling device can be self-supported. Increased rigidness and strength make solar panels more fit in building integrated facade and roof materials, and they will be more robust with regard to being able to withstand a large downfall of snow and strong wind, for example will they be able to be used as terrace floor. When the panels are mounted as building integrated facade and roof material, it is useful to let the air have free passage to circulate in accordance with thermodynamical principles so that hot air can rise up along the ribs on the back.

A further advantage of the invention is that the cooling gives the products longer life expectancy, since heat is a factor that increases the degradation rate in many of the components in a traditional photovoltaic panel.

These photovoltaic apparatuses do not need a frame. In addition, they can have a thinner outer layer, in a lighter and less costly material than the ordinary front glasses of 34 mm.

The invention will now be described by examples and with reference to the figures where:

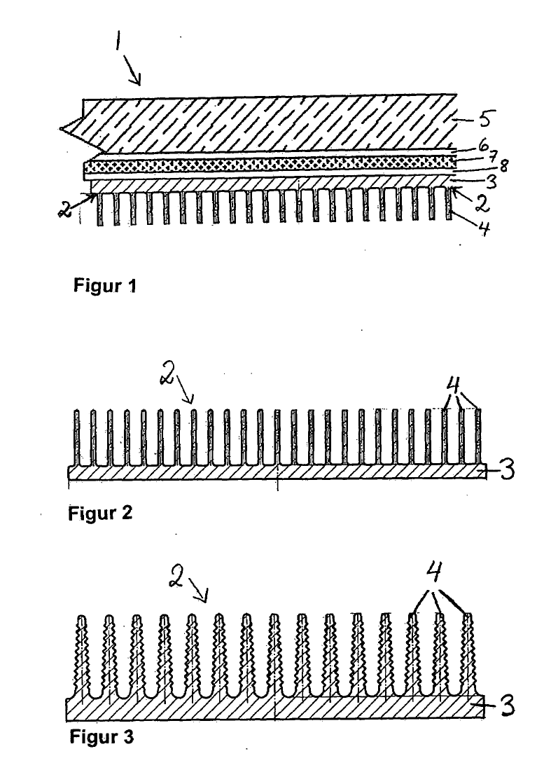

FIG. 1 shows a cross-section of a photovoltaic panel with a cooling device according to the invention.

FIG. 2 shows another embodiment of a cooling device.

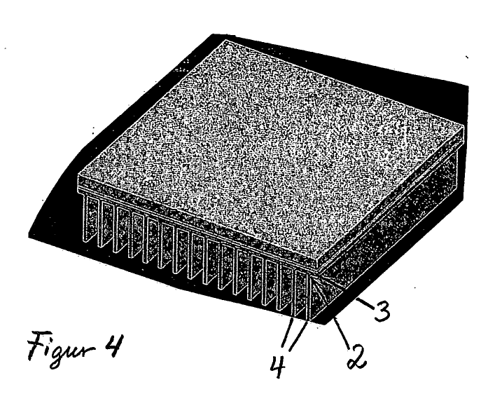

FIG. 3 shows a third embodiment of a cooling device.

FIG. 4 shows a perspective view of a photovoltaic panel with a cooling device.

FIG. 1 shows a photovoltaic panel I which comprise an embodiment of the cooling device 2 in accordance with the invention. The cooling device 2 constitutes the back of the photovoltaic panel, or is fastened to the photovoltaic panel. The cooling device 2 comprises a basis layer 3 which has a predominantly homogenous thickness. The cooling device 2 comprises further a number of protruding structures which protrude out from the basis layer 3. The photovoltaic panel 1 has a surface layer 5 on top. The surface layer 5 is often made of glass, but it can also be made of other materials, which lets through the desired wavelengths of the sunlight. The surface layer 5 can preferably be produced by a polymer material like for example PTFE. Under the surface layer 5 there is a thin layer 6 of polymer or rubber material, often EVA (ethylene vinyl acetate) is used. Subsequently there is a layer 7 with the semiconductor material where the photoelectric effect takes place. At the bottom, there is again a thin layer of polymer or rubber material 8, often EVA is used. In addition to the EVA-layer, it can be desirable to use a layer of electrically insulating material, in order to reduce the possibility of electric current leakage from the photovoltaic cells or conductors to the cooling device 2. The layers 6, 8 constitute a sealed, moist protecting layer around the semiconductor, and also fixes the two other protective layers on the top and the back. Underneath the layer 8 the cooling device 2 is fixed. The cooling device 2 with protruding structures 4 provides a large surface area to the surrounding air.

In this document the term “photovoltaic panel” will cover both “photovoltaic panel” and “photovoltaic module”.

The protruding structures 4 have preferably the shape of ribs or fins. They can preferably be elongated and parallel and adjacent to each other. The protruding structures 4 can also have other shapes like for example concentric cylinder walls that protrude out. Or the structures 4 can have the shape of squares in different sizes that have a coinciding centre which are placed outside each other. In this document the words “ribs” or “fins” will also cover these and other protruding structures with a certain extension in the plane of the photovoltaic panel.

The protruding structures 4 can also have the shape of pins or “nails”. These will however not give an increased structural rigidity to the photovoltaic panel except from the rigidity given by the basis layer 3.

The cooling device 2 has a size which covers a substantial part of the photovoltaic panel's back. Preferably the cooling device 2 covers all or nearly all of the back of the photovoltaic panel.

FIG. 1 shows an embodiment of the cooling device 2 where the structures 4 are ribs which are low and adjacent to each other. This implies that there is need for less material in order to produce the cooling device 2 which means that the photovoltaic panels will have small weight.

FIG. 2 shows another embodiment of the cooling device 2 where the structures 4 are taller. This photovoltaic panel will have a larger load carrying capacity and rigidness. It will also have increased weight.

FIG. 3 shows another embodiment of the cooling device 2 where the structures 4 have a rough surface so that the surface area is even larger than in the two other above-mentioned embodiments.

FIG. 4 is a perspective view of a photovoltaic panel with a cooling device 2.

The cooling device 2 has to be made of a material with good thermal conductivity like metals, metal alloys or special composite materials. The cooling device 2 can preferably be produced by aluminium or an aluminium alloy. Heat conductive composite materials can also be used. The cooling device 2 does not need to have a reflecting layer towards the photovoltaic cells since most photovoltaic cells have a reflecting layer on the back which reflects the sunlight which has not been absorbed by the cell.

In the following we will give an example of a method for producing a cooling device 2 in aluminium and how it is attached to the photovoltaic device.

### EXAMPLE

A press blank (block) in aluminium is heated up to approximately 500° C. and pressed with great force through a pressing tool so that the profile/cooling device 2 comes out in the desired shape and length. The tempering (heat treatment) is done with water or air so that the cooling device 2 is cooled down to room temperature. Thereafter the cooling device 2 is strained (with about 1% of its length) in order to increase tensions and for making it straight. Now the cooling device 2 is in tempering state T4. The cooling device 2 is then relatively soft and has good forming properties. The finished cooling device 2 is tempered in the tempering oven where it is kept at approximately 185° C. for about 5 hours. Thereafter a cooling period follows. The material has now been hardened.

The cooling device 2 can also be produced by sending a sheet (plate) with a completely flat top and back side into a roller with a large roller pressure. The sheet can for example have a thickness of 1 mm. The drums in the roller can have grooves which make indentations in the sheet.

The cooling device 2 is attached to the photovoltaic panel by melting together with the protective layer 8 under vacuum with a temperature of approximately 140-150° C. It is important that attachment side of the cooling device is as flat as possible, so that the contact with the cells is tight to give optimal heat transfer, and that the panel gets an even and reflection-free surface towards the sun.

It has also been done simulations with cooling devices with different heights of the ribs 4.

The heat technical input data in the simulations:

| | Value |
|---|---|
| Parameter | |
| Heat flux from sunlight | 200 W/m² |
| Conductivity | |
| Glass | 0.8 W/m · K |
| EVA | 0.34 W/m · K |
| Photovoltaic cell | as for EVA |
| Aluminium | 205 W/m · K |
| Transfer number to air | 0.004 N/mm · s · K |
| Air temperature | 30° C. |

The basis layer 3 in the cooling device had in all four simulations a thickness of 2 mm.

| | | Maximum |
|---|---|---|
| | | photovoltaic cell |
| No. | | temperature |
| 1 | Only basis layer of 2 mm | 81.1° C. |
| 2 | Basis layer and ribs with a thickness of 1.5 mm | 50.5° C. |
| | and a height of 10 mm | |
| 3 | Basis layer and ribs with a thickness of 1.5 mm | 43.3° C. |
| | and a height of 20 mm | |
| 4 | Basis layer and ribs with a thickness of 1.5 mm | 40.2° C. |
| | and a height of 30 mm | |

The simulations indicate that the maximum temperature of the photovoltaic panel has decreased with 30° C. when the ribs have a height of 10 mm and with almost 38° C. when the ribs have a height of 20 mm.

1. Cooling device (2) for photovoltaic panel (1)
characterized in that the cooling device (2) comprises a basis layer (3) with a number of protruding structures (4) which protrudes out from the basis layer (3) and in that cooling device (2) covers a substantial part of the back of the photovoltaic panel.

2. Cooling device (2) according to claim 1,
characterized in that the protruding structures (4) are ribs.

3. Cooling device (2) according to claim 1,
characterized in that the cooling device (2) covers substantially all of the back of the solar panel.

4. Cooling device (2) according to claim 1,
characterized in that the basis layer(3) have a homogeneous thickness.

5. Cooling device (2) according to claim 1,
characterized in that the cooling device is made by a metal or a metal alloy.

6. Cooling device (2) according to claim 5,
characterized in that the cooling device is made of aluminium or an aluminium alloy.

7. Photovoltaic panel comprising a cooling device (2) according to claim 1.
